(19) United States
(12) Patent Application Publication
(10) Pub. No.: US 2014/0101032 A1
(43) Pub. Date: Apr. 10, 2014

(54) Rights Management and Content Distribution Platform

(71) Applicant: RED.COM, INC., IRVINE, CA (US)

(72) Inventor: Jon A. Farhat, Burbank, CA (US)

(73) Assignee: RED.COM, INC., IRVINE, CA (US)

(21) Appl. No.: 13/926,557

(22) Filed: Jun. 25, 2013

Related U.S. Application Data
(60) Provisional application No. 61/711,614, filed on Oct. 9, 2012.

(51) Int. Cl. G06F 21/10

(52) U.S. Cl. CPC G06F 21/10
USPC 705/39; 726/27

(57) ABSTRACT

Apparatus, systems and methods in which one can leverage an ecosystem capable of managing rights with respect to digital content while allowing a content consumer to obtain the digital content through multiple paths.

### FIELD OF THE INVENTION

The field of the invention is digital content management technologies.

### BACKGROUND

Providing digital content to consumers at home or through commercial venues (e.g., theaters, kiosk, Internet, etc.) continues to be an ever growing problem. One of the main issues encountered with providing content includes ensuring that the owners of rights related to the content have their rights protected through the entire distribution ecosystem. Unfortunately, existing ecosystems attempt to bind rights management closely with the content, which frustrates the consumer and hinders revenue generation.

For example, consider the distribution model disclosed in U.S. Pat. No. 8,055,585 to Wu titled “Digital Media Distribution”, filed Aug. 12, 2004. Wu contemplates a centralized system that provides encrypted movies through a distribution station. Such an approach requires a content consumer only one possible path to obtain the content they have purchased. A better approach would decouple the distribution system from the rights management to allow content consumers multiple routes to obtain their purchased content.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As discussed herein, the applicant has appreciated that decoupling rights management from content distribution frees the consumer to obtain content through multiple, easy access routes while also ensure rights owners have their rights preserved.

Thus, there is still a need for improved content distribution and rights management platforms or agents.

### SUMMARY OF THE INVENTION

The inventive subject matter provides apparatus, systems and methods in which one can leverage an ecosystem capable of managing rights with respect to digital content while allowing a content consumer to obtain the digital content through multiple paths. One aspect of the inventive subject matter includes a rights management and distribution platform where one or more remote services govern how digital assets are consumed via a media player. The service, possibly operating on one or more servers (e.g., cloud, PaaS, IaaS, SaaS, etc.), provides keys or other tokens to agents located on the media player. Of particular note, the agent is considered a distinct manageable object that restricts access or rendering features to the media asset based on commands or parameters encoded within the keys. The media asset can be secured via one or more complementary security features, a 4096 bit key for example. In such embodiments, content consumers can obtain the media asset through any desired route, possibly obtaining the asset from an on-line site, a disk, a thumb drive, a peer-to-peer network, or through other avenue.

Another aspect of the inventive subject matter includes a media player agent disposed within a media player. The agent represents a distinct entity or module capable of controlling capabilities of a corresponding media player with respect to authorization of rendering media assets (e.g., video, audio, movies, games, applications, etc.). In some embodiments, the media agent comprises an actual network node within a management or content distribution network. For example, the agent can function as a peer-to-peer node (e.g., BitTorrent, etc), where the agent can supply content or receive content from other agents. Further, the agent can govern access to media assets through one or more interfaces presented via the media player. Example interfaces can include a cell-based interface where the agent governs how feeds are presented within each cell of the interface.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of rights management and content distribution system.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating control signals from a rights management platform where the signals are transported over network to control an agent within a media player. The agent commands the media player to render one or more media assets according to the command signals.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. The terms “coupled to” and “coupled with” are also use euphemistically to mean “communicatively coupled with” in a networking sense where at least two networked elements are able to communicate with each other over a network possibly via one or more intermediary devices.

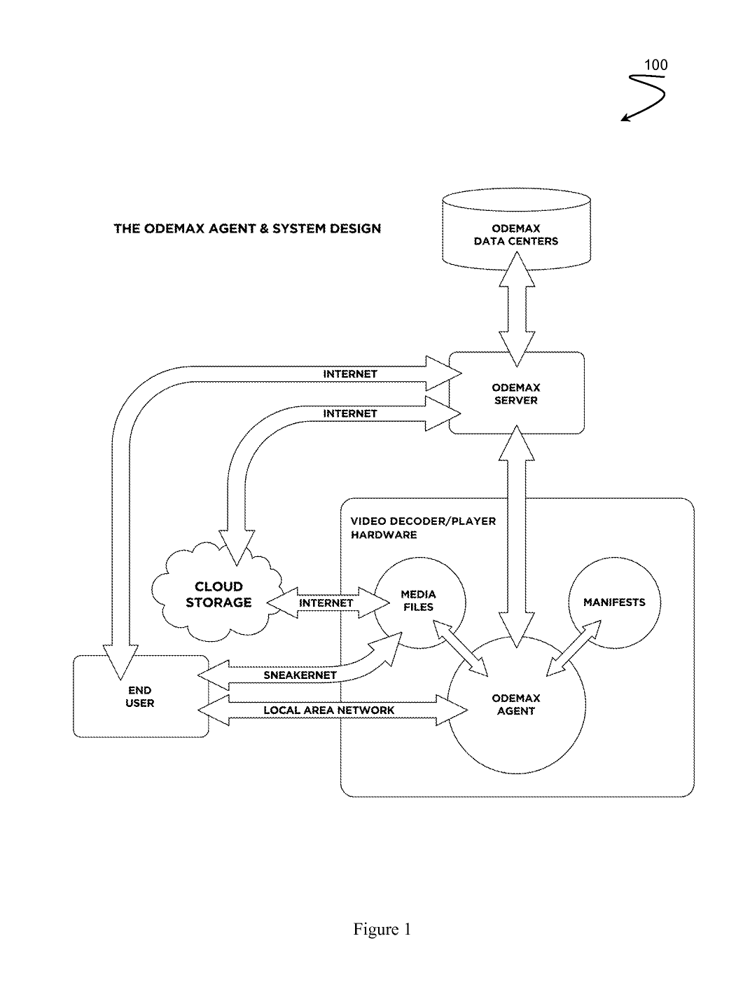

In FIG. 1, ecosystem 100 illustrates an environment in which right management is decoupled from content distribution. In the example shown, an agent (ODEMAX Agent) is disposed within a media player (REDRAY/CRIMSON Hardware) and operates under instructions received from a management server (ODEMAX Server). The agent controls the circumstances under which the media player renders or accesses digital assets (Media Files). In some embodiments, the digital assets are secured through one or more techniques which substantially make the content in the digital assets inaccessible by content consumes unless the agent permits the media player to access the content. Such an approach is considered advantageous because the assets can be obtained through nearly any route as illustrated. For example, the assets can be obtained from the content servers (ODEMAX Server) or data centers (ODEMAX Data Centers), from cloud-based storage (e.g., DropBox®, Google®, Skydrive®, etc.), end users, thumb drives, peer-to-peer networks, or any other source.

### Management and Distribution Platform

The management or distribution platform includes a broad spectrum of concepts that related to managing rights to digital assets or distributing content to media players via an independent agent within the media player. The following items describe features of the contemplated distribution platform.

Distribution Platform

The ODEMAX platform delivers media and authorization keys to a player through an agent as shown in FIG. 1.

Key Management

Provide one or more keys to a player where the keys authorize the player to present content. ODEMAX operates as a key authority.

Key is a generic term for any form of authorization code or set of tokens. Keys can include public-private keys or other security infrastructure.

Keys can include encoded information that dictates control of player actions with respect to an asset. Tokens or keys can include bit fields or other fields corresponding to features or capabilities that authorize access to a specific asset.

Keys can govern back-end analytic and account interactions between agent and ODEMAX servers.

Keys can represent rights to consume content.

Keys can dictate licensing terms.

Obtaining the key can include receiving a key from an asset management system that determines each asset's key and can also include the key authority system generating keys.

Key managers can construct a key object based on actual keys and other restrictions. The key object can then be sent to the agent, which in turn decodes the key object to determine who the player can interact with the media.

Interactions can include time shifting, player control, media control, features, commentaries, transactions (especially financial transactions), or other types of interactions.

Revenue Management

Contemplated platforms provide access to accounting systems that govern allocation of revenue from asset authorization.

The platform can include a rules engine that operates based on a set of business rules. The business rules interact with accounts according to actions reported by agent.

Transactions can occur based on one or more triggers; in real-time, agent actions, player-user interactions, per use, per play, according to functions related to content consumption, or other types of criteria.

The accounting system can also be bound to keys to direct revenue generation where the account system applies revenue routing based on directives decoded from the keys.

The account system can provide direct media provider account management based on real-world metrics (e.g., actual views) without requiring interaction of intermediaries (e.g., no studios).

Conducting transactions include initiating financial transactions among multiple accounts associated with the media provider.

Transactions can include non-financial transactions possibly related to different types of accounts (e.g., Amazon, eBay, etc), protocol transactions, or even with respect to analytics.

The platform can include an accounting system or module that can provide licenses to assets based on a broad spectrum of terms: per venue, per screen, per seat, time, location, etc.

An aspect of the invention provides a revenue management system comprising: an agent interface configured to communicate with an media player agent; and a rules engine coupled with the agent interface and configured to: obtain a revenue distribution rule sets associated with a media asset; receive a media event signal via the agent interface and associated with the media asset; and allocate portions of revenue related to the media asset according to the revenue distribution rule sets.

A further aspect of the invention provides a method of conducting a transaction comprising: providing access to a media asset from a media provider; receiving a media event signal from a media agent and related to the media asset; selecting at least one target account based on the media event associated with the media provider; and initiating a transaction with the at least one target account.

Analytics

The disclosed platform and its representative services acquire player or user metrics from the player agent. Metrics can include player specific interaction or can include user information (e.g., demographic, actions taken, viewer preferences, viewer, history, etc.).

The platform can be configured to provide analytic tools to researchers (e.g., studios, media providers, advertisers, etc.) through which the researchers can construct business logic governing revenue generating activities. Example activities include providing advertisements, monetizing agent-to-agent interactions, directing earned revenue, or other activities.

Analytics engines can monitor trends, history, correlations, or other analytical features. As the engine monitors such features, it can take actions based on triggering criteria. Actions include initiating a transaction, reporting, offering recommendations, alerting, conducting inventory, recovery, enforcing security, or other actions.

Metrics and analytics have various scales. Such features can reflect the entire distribution network as a whole, portions of the network, groups or affiliations, individual agents, individual players, individual users, or even down to individual interactions with media assets. Thus, the metrics provide a fractal view of the ecosystem.

A further aspect of the invention provides a media asset analytics system comprising: a media player agent interface; an analytics database; and an analytics engine that receives media metrics related to media assets via the media play agent interfaces, compiles the media metrics in an analytic object, and stores the analytic object in the analytics database.

Residual Administration

Along with the accounting system discussed above, the platform can provide a residual interface through which a media producer can construct a residual structure. Payout structure can include business rules defining how payments should be made to whom, when, where, etc. For example, rules can be based on a person's role in a production (e.g., actor, artist, grip, etc.).

In another aspect, the invention provides a media provider residual management system comprising: an residual management interface; and a residual management engine coupled with the media provider management interface and configured to: receive residual distribution model from a user via the residual management interface; and configure a transaction system to distribute residuals according to the distribution model.

Aggregated NOC

The platform can also operate as a service, which can provide a “playlist” scheduling for independent theaters, or other venues, wishing to automate their presentation of assets.

In some embodiments, the platform can include recommendation engine that generated recommendations on when to play or which content to play. The platform then provides access to media assets where “access” is considered to include the concept of control over the content (e.g., player functionality, time shifting, etc.)

The aggregate NOC can monitor screen attributes (e.g., number of seats; expected occupancy; etc.) with respect to content, possibly through the analytics engine discussed above.

The NOC can provide its service to collection of theaters, independent groups, family members, or other types of affiliations. Thus, the NOC could provide its services across multiple independent franchise owners.

Communications between NOC and individual media players can be bi-directional. Thus, the NOC can adjust prices through business rules based on actual metrics received through the agent via the player.

Network Flow

The platform can aggregate agent IDs (IP address; etc.) and can manage many media players via their corresponding agents as describe above with respect to the “Distribution Platform”.

The platform monitors which media files are available to the media players as reported by the agent within the media player.

Further, the platform can seed each player with assets base on the metrics received from the media player or players. In cases where the media player lacks the media assets, the platform can provide one or more pointers (e.g., network address, venue locations, etc.) to downloadable assets as desired or as governed by user purchases.

### Media Player Agent

The media player agent can be considered an independent module that governs how a media player should or is permitted to access secured assets. The following items outline possible features of the agent.

Player Control

The agent comprises module (e.g., hardware, software, firmware, etc.) within a player that governs which rights the player has with respect to rendering a media item.

The agent commands and controls player based on keys (device identifier, media identifier). Key unlocks content within the asset or indicates which features or capabilities are authorized to the player.

The agent control over media player provided through signals generated by the agent, possibly through interpretation of key, and passed to the player via an agent-player interface (e.g., API, shared memory, remote procedure calls, etc.).

The agent instructs the player how to render the assets. Rendering represents various functionalities, all of which can be controlled. Examples include resolution, time shifting, play times, volume control, user authorization, play length, portions of a media asset, advertisements, sound quality, target display, or other capabilities.

The agent authorizes play based on corresponding licenses or keys.

Agent signals that represent commands can include discovery (e.g., UDP broadcast, cross-firewall discovery, etc.), registration, status or information regarding agent and player, assets and agent state control (e.g., play, pay, pause, stop, rewind, forward, load, etc.), content management, display presentation information, or other type of commands.

Seeding and Seeding Management

The agent can include one or more media modules to receive or send media content or other types of assets.

The agent can support many different methods to obtain media assets including through peer-to-peer networks (e.g., BitTorrent), USENET, FTP, HTTP, sneaker net, USB thumb drive, or other methods to obtain the assets. One should appreciate that agent can operate independent of the asset source.

The agent can obtain content based on one or more characteristics: player use; user preferences; tracked user behaviors; “nearest neighbor” requirements, or other analytics. In view that the agent can operate as a client or server in the distribution network, the agent can obtain “seeded content” as well as provide “seeded content” based on network address namespace (e.g., bit torrent address).

In view that the agent can provide content, it can be considered a media server for other agents within the ecosystem.

Cell-Based Interface

In addition to controlling how a player accesses or renders assets, the agent can instructs player to present user interface through which a user can access content within the assets.

The user interface can include “cells” illustrating content that is available or authorized for presentation. Multiple cells can be presented in a matrix of cells (e.g., 2×2, 2×3, 3×3, etc.).

Each “cell” in a matrix of cells can include sub-cells through which the user can drill down for added information or content.

The agent can bind channel or station content to each according to one or more keys. Thus each cell can be considered a feed or stream of rendered content.

Contemplated agents manage feeds directly or indirectly to each cell. The presentation of cells can be based off local control or remote control through the back end platform. One should remember the agent dictates a player's capabilities with respect to media assets in the cells.

Networking Node

Disclosed agents comprise a node on the rights distribution network of FIG. 1. From the distribution network perspective the agent IS a network device. Thus, the agents across thousands of players can be considered to form a network cloud.

The agent can have its own network address distinct from a player address. Thus, the agent gives rise to a multi-homed player. For example, the agent could include its own IP address or have a BitTorrent address.

Network addresses can include domains, URL, GUID, hash in an address space, IP address (e.g., IPv4 or IPv6), or other type of addresses.

Media Event Reporting

The agent can report media events to the platform to give rise to analytics as discussed above.

The agent can include one or more reporting modules that monitor local events relating to the media assets. As events are detected through one or more trigger criteria, the reporting modules can compile corresponding event information (e.g., metric, trends, etc.)

The reporting module operates based on reporting rules. The rules can define event information, trigger criteria, filtering, or other types of rules.

Events can be directly related to the media assets (e.g., play, rewind, purchase, etc.) or indirectly related (e.g., pass by asset, searched for by genre or category).

Events can be related to the agent where agent events likely focus on management or administrative aspects.

Event can be related to the player or venue.

In another aspect, the invention provides a media center management system for a plurality of independent media centers having media players comprising: a media center module that couples with the media players of the plurality of independent media centers; an asset scheduling library storing asset schedules from individual ones of the plurality of independent media centers; and a media manager that authorizes, via the media center module, the media players to access media assets at each of the media centers according to their asset schedules.

Yet another aspect of the invention provides a method of authorizing access to a media asset located on a media player, the method comprising: providing access to an authorization server remote from the media player; receiving, by the authorization server, an agent ID of an agent disposed within the player; receiving, by the server, a set of media asset IDs of media assets local to the player; instructing, by the server, the agent to obtain portions of the media assets; and configuring, by the server, the agent to allow the media player to control the media assets.

A further aspect of the invention provides a device authorization agent configure to facilitate rendering of a media item by a media player device, but executing digital commands to: obtain a device identifier (DID) for the media player, and a media identifier (MID) for the media item; and utilize the DID and MID to provide a key to the media player device to render the media item.

Another aspect of the invention provides a method of seeding a media player with media assets comprising: providing access to an agent on the media player; establish a seeding policy for the media player based on analytics related to the media player; obtaining, by the agent, at least portions of the media assets from at least one remote media server according to the seeding policy; and enabling, by the agent, the media player to present the at least portions of the media assets.

An additional aspect of the invention provides a media player agent disposed within a media player comprising: a media player connection; a user interface manager configured to: identifying a set of authorized media assets available to the media player; construct a cell-based user interface having at least one cell for each member of the set of authorized media assets; instruct the media player to present the cell-based user interface via the media player connection.

A further aspect of the invention provides a network addressable agent disposed within a media player comprising: a memory storing a network address of the media agent, the network address falling within a cloud-based address space; an agent server responsive to the network address and that disseminates media asset data from the media player to other remote agents that are remote from the media player; an agent client responsive to the network address and that receives media asset data from the other remote agents; and an authorization module that authorizes the media player to access the media asset data.

Another aspect of the invention provides a reporting engine within a media player that reports information to an analytics server, comprising: a network interface configured to communicatively couple with the remote analytics server; and a media agent coupled with the network interface and configured to: obtain a media event reporting policy defining event conditions related to the media player; detect an event with respect to a media asset associated with the media player based on event detection criteria in the reporting policy; compile event information based on the event and according to rules within the reporting policy; and transmit the event information over a network to the remote analytics server.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A distribution platform for use with (a) a media item and (b) a media player device configured to limit rendering of the media item through application of a rendering authorization, the platform comprising:
an authorization agent that transmits a device identifier (DID) and a media identifier (MID) to an authorization system (RAS), and provides a rendering authorization to the media player device; and
a payment agent that facilitates a payment to a stakeholder involved in distribution of at least one of the media item and the media rendering device, the payment calculated at least in part as a function of a number of renderings of the media item.

2. A key authority system comprising:
a key database storing configured to store key objects, each key object encoded with media control points; and
a key manager coupled with the key database and configured to:
receive a request for authorization to access a media assets;
obtain a key object from the key database corresponding to the media asset in response to the request; and
configure an agent to enable access to the media asset according to media control points of the key.

3. A key delivery system comprising:
A key management interface; and
A key manager coupled with the key management interface and configured to:
obtain a key that restricts access to a media asset via the key management interface;
obtain a set of media access interactions related to the media assets;
instantiate a key object based on the key and the set of media access interactions; and
enable an agent to control a media player with respect to the media assets via the key object.
